(19) United States
(12) Patent Application Publication
(10) Pub. No.: US 2015/0055587 A1
(43) Pub. Date: Feb. 26, 2015

(54) SYSTEMS, METHODS, AND APPARATUS FOR INCREASING REUSE IN WIRELESS COMMUNICATIONS

(71) Applicant: QUALCOMM Incorporated, San Diego, CA (US)

(72) Inventors: Hemanth Sampath, San Diego, CA (US); Simone Merlin, Solane Beach, CA (US); Sameer Vermani, San Diego, CA (US); Gwendolyn Denise Barriac, Encinitas, CA (US)

(21) Appl. No.: 14/457,786

(22) Filed: Aug. 12, 2014

Related U.S. Application Data
(60) Provisional application No. 61/869,546, filed on Aug. 23, 2013.

(51) Int. Cl. H04W 72/04

(52) U.S. Cl. CPC H04W 72/0493
USPC 370/329

(57) ABSTRACT

Systems, methods, and apparatus are disclosed for increasing reuse in wireless communications. In one aspect, a method of wireless communication is provided, transmitting a message to a first station indicating an identified transmission opportunity for the first station to communicate with a second station. The method further comprises transmitting a first wireless communication signal to at least a third station utilizing beamformed wireless communication such that the first wireless communication signal to the third station has a received signal level below a threshold at one or both of the first and second stations. The identified transmission opportunity is based on whether a transmission of a second wireless communication signal between the first and the second stations occurs over a period of time that is at least partially concurrent with the utilized beamformed communication.

### CROSS REFERENCE TO RELATED APPLICATIONS

This application claims priority under 35 U.S.C. §119(e) to U.S. Provisional Patent Application No. 61/869,546 entitled “SYSTEMS, METHODS, AND APPARATUS FOR INCREASING REUSE IN WIRELESS COMMUNICATIONS” filed on Aug. 23, 2013 the disclosure of which is hereby incorporated by reference in its entirety.

### BACKGROUND

1. Field

The present application relates generally to wireless communications, and more specifically to systems, methods, and devices for increasing reuse in wireless communication.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

However, multiple wireless networks may exist in the same building, in nearby buildings, and/or in the same outdoor area. The prevalence of multiple wireless networks may cause interference, reduced throughput (e.g., because each wireless network is operating in the same area and/or spectrum), and/or prevent certain devices from communicating. Thus, improved systems, methods, and devices for communicating when wireless networks are densely populated are desired.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the subject matter described in the disclosure provides a method for wireless communication. The method comprises transmitting a message to a first station indicating an identified transmission opportunity for the first station to communicate with a second station. The method further comprises transmitting a first wireless communication signal to at least a third station utilizing beamformed wireless communication such that the first wireless communication signal to the third station has a received signal level below a threshold at one or both of the first and second stations. The identified transmission opportunity is based on whether a transmission of a second wireless communication signal between the first and the second stations occurs over a period of time that is at least partially concurrent with the utilized beamformed communication.

Another aspect of the subject matter described in the disclosure provides an apparatus for wireless communication. The apparatus comprises a transmitter configured to transmit a message to a first station indicating an identified transmission opportunity for the first station to communicate with a second station, the transmitter further configured to transmit a first wireless communication signal to at least a third station utilizing beamformed wireless communication such that the first wireless communication signal to the third station has a received signal level below a threshold at one or both of the first and second stations. The identified transmission opportunity is based on whether a transmission of a second wireless communication signal between the first and the second stations occurs over a period of time that is at least partially concurrent with the utilized beamformed communication.

Another aspect of the subject matter described in the disclosure provides an apparatus for wireless communication. The apparatus comprises means for transmitting a message to a first station indicating an identified transmission opportunity for the first station to communicate with a second station. The apparatus further comprises means for transmitting a first wireless communication signal to at least a third station utilizing beamformed wireless communication such that the first wireless communication signal to the third station has a received signal level below a threshold at one or both of the first and second stations. The identified transmission opportunity is based on whether a transmission of a second wireless communication signal between the first and the second stations occurs over a period of time that is at least partially concurrent with the utilized beamformed communication.

### BRIEF DESCRIPTION OF THE DRAWINGS

FIG. 1 illustrates an example of a wireless communication system in which aspects of the present disclosure may be employed.

FIG. 2A illustrates a wireless communication system in which multiple wireless communication networks are present.

FIG. 2B illustrates an example of transmissions in a wireless communication system in which multiple wireless devices are present.

FIG. 3 illustrates various components that may be utilized in a wireless device that may be employed within a wireless communication system.

FIG. 4 illustrates one exemplary embodiment of a channel state information (CSI) sequence.

FIG. 5 illustrates another exemplary embodiment of a CSI sequence.

FIG. 6 illustrates another example of transmissions in a wireless communication system in which multiple wireless devices are present.

FIG. 7 illustrates an exemplary structure of a physical layer data unit (PPDU).

FIG. 8 illustrates another exemplary structure of a PPDU.

FIG. 9 illustrates another exemplary embodiment of a CSI sequence.

FIG. 10 illustrates another example of transmissions in a wireless communication system in which multiple wireless devices are present.

FIG. 11 illustrates another exemplary embodiment of a CSI sequence.

FIG. 12 illustrates another exemplary embodiment of a CSI sequence.

FIG. 13 illustrates a flowchart of an exemplary method of wireless communication, in accordance with certain embodiments described herein.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as WiFi or, more generally, any member of the IEEE 802.11 family of wireless protocols.

In some implementations, a WLAN includes various devices which are the components that access the wireless network. For example, there may be two types of devices: access points (“APs”) and clients (also referred to as stations, or “STAs”). In general, an AP serves as a hub or base station for the WLAN and an STA serves as a user of the WLAN. For example, a STA may be a laptop computer, a personal digital assistant (PDA), a mobile phone, etc. In an example, an STA connects to an AP via a WiFi (e.g., IEEE 802.11 protocol) compliant wireless link to obtain general connectivity to the Internet or to other wide area networks. In some implementations an STA may also be used as an AP.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. A TDMA system may implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An OFDM system may implement IEEE 802.11 or some other standards known in the art. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A SC-FDMA system may implement 3GPP-LTE (3rd Generation Partnership Project Long Term Evolution) or other standards.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

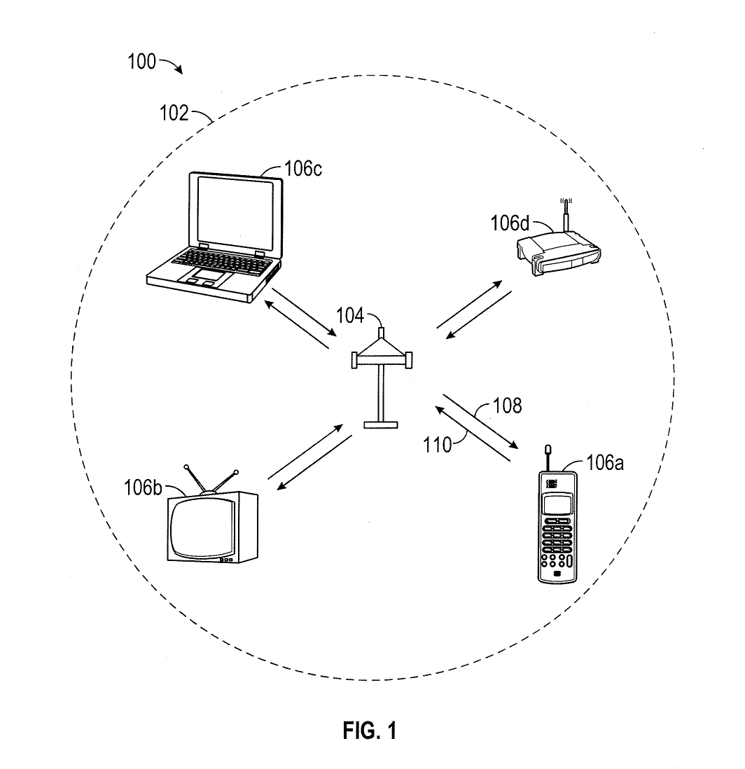

FIG. 1 is a diagram of an exemplary wireless communication system 100 in which aspects of the present disclosure may be employed. The wireless communication system 100 may operate pursuant to a wireless standard, for example a high-efficiency 802.11 standard. The wireless communication system 100 may include an AP 104, which communicates with STAs 106 (referring generally to the STAs 106A-106D).

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with code division multiple access (CDMA) techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel. This communication link may be established via a single-input-single-output (SISO), multiple-input-single-output (MISO), single-input-multiple-output (SIMO), or a multiple-input-multiple output (MIMO) system.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network (e.g. TDLS, WiFi-Direct) between the STAs 106. Accordingly, the functions of the AP 104 described herein may alternatively be performed by one or more of the STAs 106.

In some aspects, a STA 106 may be required to associate with the AP 104 in order to send communications to and/or receive communications from the AP 104. In one aspect, information for associating is included in a broadcast by the AP 104. To receive such a broadcast, the STA 106 may, for example, perform a broad coverage search over a coverage region. A search may also be performed by the STA 106 by sweeping a coverage region in a lighthouse fashion, for example. After receiving the information for associating, the STA 106 may transmit a reference signal, such as an association probe or request, to the AP 104. In some aspects, the AP 104 may use backhaul services, for example, to communicate with a larger network, such as the Internet or a public switched telephone network (PSTN).

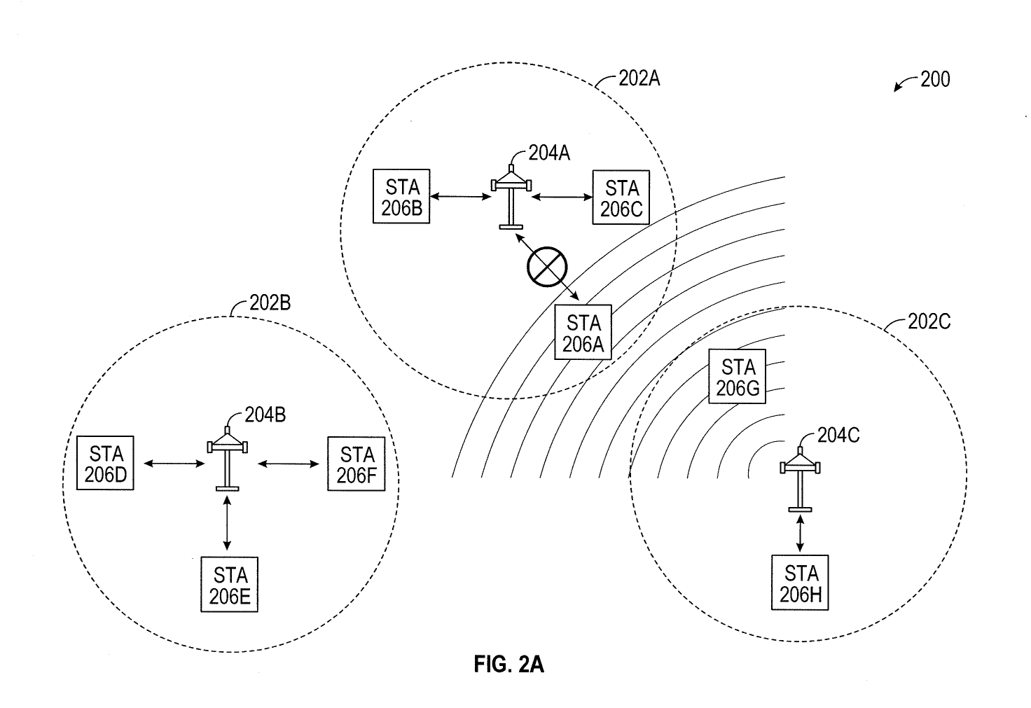

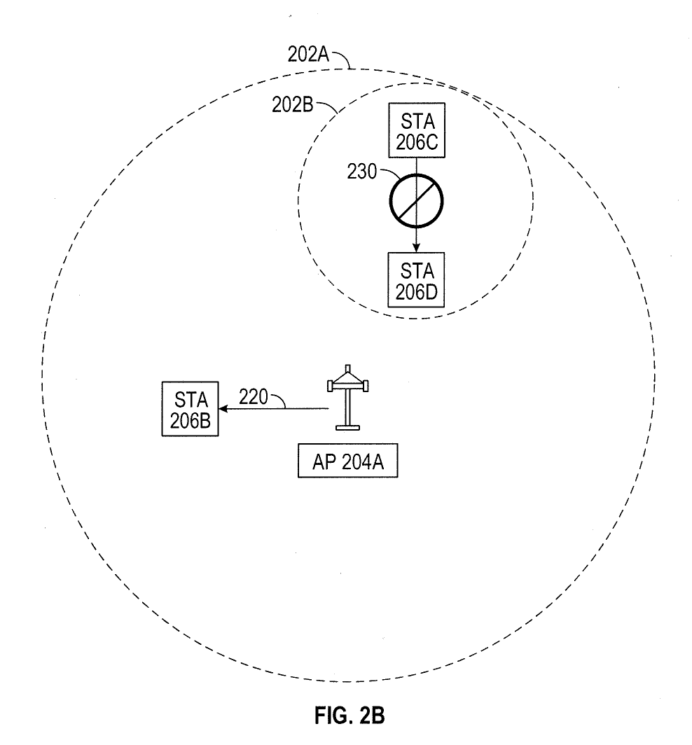

In some circumstances, a BSA may be located near other BSAs. For example, FIG. 2A is a diagram of a wireless communication system 200 in which multiple wireless communication networks are present. As illustrated in FIG. 2A, BSAs 202A, 202B, and 202C may be physically located near each other. Despite the close proximity of the BSAs 202A-202C, the APs 204A-204C and/or STAs 206A-206H may each communicate using the same spectrum. Thus, if a device in the BSA 202C (e.g., the AP 204C) is transmitting data, devices outside the BSA 202C (e.g., APs 204A-204B or STAs 206A-206F) may sense the communication on the medium.

Generally, wireless networks that use a regular 802.11 protocol (e.g., 802.11a, 802.11b, 802.11ac, 802.11g, 802.11n, etc.) operate under a carrier sense multiple access (CSMA) mechanism for medium access. According to CSMA, devices sense the medium and only transmit when the medium is sensed to be idle. Thus, if the APs 204A-204C and/or STAs 206A-206H are operating according to the CSMA mechanism and a device in the BSA 202C (e.g., the AP 204C) is transmitting data, then the APs 204A-204B and/or STAs 206A-206F outside of the BSA 202C may not transmit over the medium even though they are part of a different BSA.

FIG. 2A illustrates such a situation. As illustrated in FIG. 2A, AP 204C is transmitting over the medium. The transmission is sensed by STA 206G, which is in the same BSA 202C as the AP 204C, and by STA 206A, which is in a different BSA than the AP 204C. While the transmission may be addressed to the STA 206G and/or only STAs in the BSA 202C, STA 206A nonetheless may not be able to transmit or receive communications (e.g., to or from the AP 204A) until the AP 204C (and any other device) is no longer transmitting on the medium. Although not shown, the same may apply to STAs 206D-206F in the BSA 202B and/or STAs 206B-206C in the BSA 202A as well (e.g., if the transmission by the AP 204C is stronger such that the other STAs can sense the transmission on the medium).

FIG. 2B is a diagram of a situation where AP 204A is transmitting a message 220 over the medium to STA 206B. The transmission is sensed by STA 206C and STA 206D in the same BSA 202A. STAs 206C and STA 206D may not be able to transmit or receive communication 230 (e.g., to or from the AP 204A or to from each other) until the AP 204A (and any other device) is no longer transmitting on the medium.

The use of the CSMA mechanism may create inefficiencies because some APs or STAs located inside or outside of a BSA may be able to transmit data without interfering with a transmission made by an AP or STA in the BSA. As the number of active wireless devices continues to grow, the inefficiencies may begin to significantly affect network latency and throughput. For example, significant network latency issues may appear in apartment buildings, in which each apartment unit may include an access point and associated stations. In fact, each apartment unit may include multiple access points, as a resident may own a wireless router, a video game console with wireless media center capabilities, a television with wireless media center capabilities, a cell phone that can act like a personal hot-spot, and/or the like. Correcting the inefficiencies of the CSMA mechanism may then be vital to avoid latency and throughput issues and overall user dissatisfaction.

Such latency and throughput issues may not even be confined to residential areas. For example, multiple access points may be located in airports, subway stations, and/or other densely-populated public spaces. Currently, WiFi access may be offered in these public spaces, but for a fee. If the inefficiencies created by the CSMA mechanism are not corrected, then operators of the wireless networks may lose customers as the fees and lower quality of service begin to outweigh any benefits.

Accordingly, the high-efficiency 802.11 protocol described herein may allow for devices to operate under a modified mechanism that minimizes these inefficiencies and increases network throughput. Such a mechanism is described below with respect to FIGS. 5-12. Additional aspects of the high-efficiency 802.11 protocol are described below with respect to FIGS. 5-12.

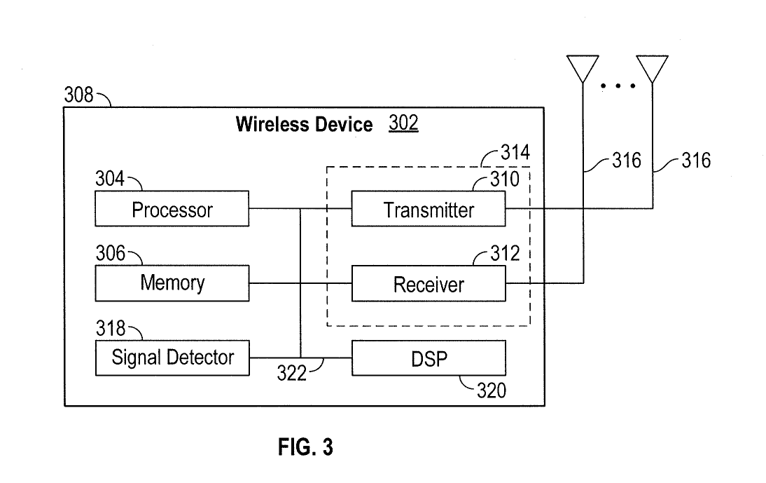

FIG. 3 is a block diagram that illustrates various components that may be utilized in a wireless device 302 that may be employed within the wireless communication system 100. The wireless device 302 is an example of a device that may be configured to implement the various methods described herein. The wireless device 302 may implement an AP 104 or a STA 106.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 may perform logical and arithmetic operations based on program instructions stored within the memory 306. The instructions in the memory 306 may be executable to implement the methods described herein.

The processor 304 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transceiver antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

Although a number of separate components are illustrated in FIG. 3, those of skill in the art will recognize that one or more of the components may be combined or commonly implemented. For example, the processor 304 may be used to implement not only the functionality described above with respect to the processor 304, but also to implement the functionality described above with respect to the signal detector 318 and/or the DSP 320. Further, each of the components illustrated in FIG. 3 may be implemented using a plurality of separate elements.

The wireless device 302 may comprise an AP 104, a STA 106, an AP 204, and/or a STA 206, and may be used to transmit and/or receive communications. That is, either AP 104, STA 106, AP 204, or STA 206 may serve as transmitter or receiver devices. Certain aspects contemplate signal detector 318 being used by software running on memory 306 and processor 304 to detect the presence of a transmitter or receiver.

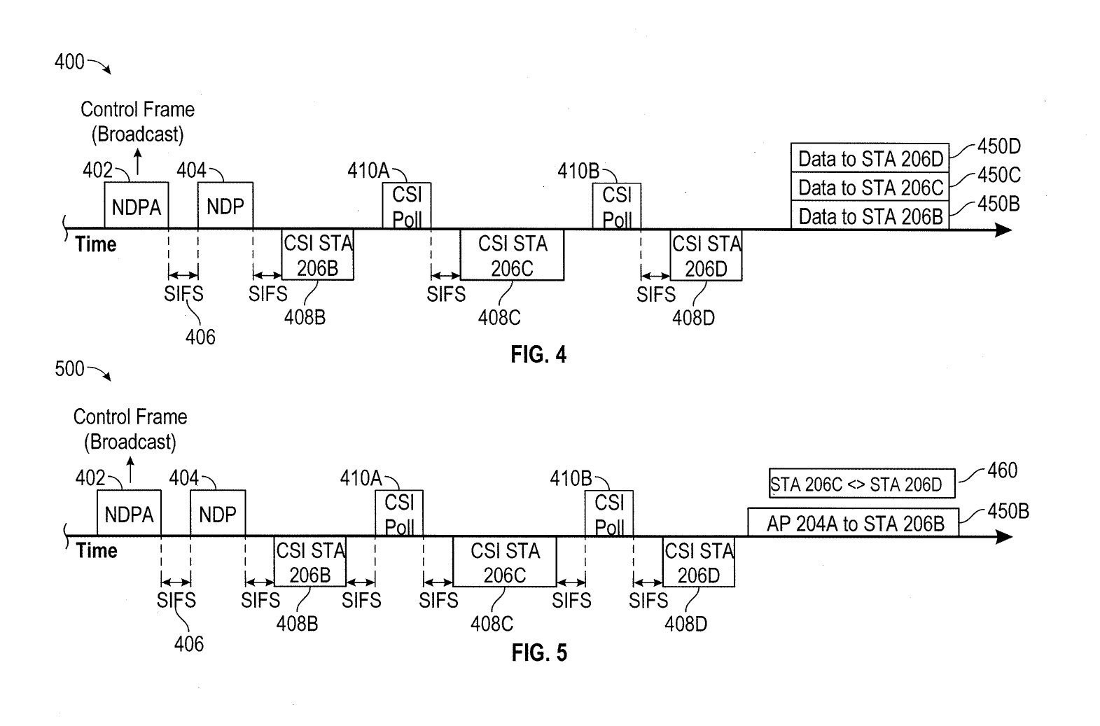

In some aspects, the wireless system 100 illustrated in FIG. 1 operates in accordance with IEEE 802.11ac wireless communications standard. The 802.11ac provides a protocol for establishing communication links in a multi-user MIMO (MU-MIMO) system. In this system, an AP collects channel state information (CSI) from the STAs. FIG. 4 is a sequence diagram illustrating a CSI feedback (FB) sequence 400 where there is an exchange of messages between STA 206B-D and AP 204A. In this embodiment, the CSI FB sequence 400 may start with the AP 204A sending a null data packet announcement frame (NDPA) 402 and then a null data packet (NDP) 404 after a short interframe space (SIFS) 406. The NDPA 402 contains the STA association identifiers (AIDs) of the STAs 206 that should send computed CSI FB 408 to the AP 204A. STAs not listed in the NDPA 402 ignore the following NDP 404, allowing for power saving. The first listed STA in the NDPA 402 (STA 206B as shown) then sends CSI FB 408 after a SIFS following the NDP 404. In one aspect, the AP 204A shall poll all of the STAs 206 listed in the NDPA 402 message by using a CSI poll message 410. The CSI poll message 410A for the next STA (STA 206C as shown) shall be sent SFIS 406 time after receiving the CSI FB 408 of the current STA (STA 206B as shown). The CSI FB sequence 400 then continues until receiving CSI FB 408 from all STAs listed in the NDPA 402 message. The AP 204A then uses the CSI FB 408 from the STAs to precode data 450B-D sent by the antennas 316 of the AP 204A.

FIG. 5 is a sequence diagram illustrating an embodiment utilizing a CSI FB sequence 500 to send multiple transmissions at least partially concurrently. In this embodiment, all the STAs are associated with the AP 204A and all the STAs 206 and AP 204A have multiple transceiver antennas 316. The AP 204A collects CSI FB 408 from the STAs 206 as described above and as shown in FIGS. 4 and 5. AP 204A then precodes the data such that it sends a data packet 450B to STA 206B and substantially nulls interference 460 at STA 206C and STA 206D. In other embodiments, AP 204A may null interference or send data signals to other STAs 206 or to other antennas 316 on STA 206C or STA 206D to create other communication channels. The number of useful data streams that AP 204A may create is limited by the number of antennas 316 it has.

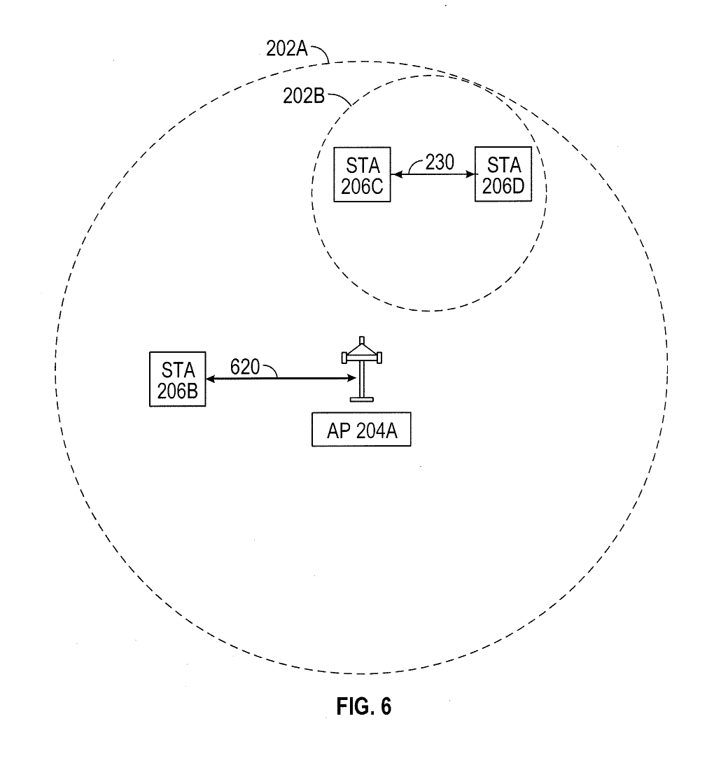

FIG. 6 is a diagram that illustrates the antenna 316 transmissions of FIG. 5 and described above. In this embodiment, AP 204A is transmitting a beamformed message 620 over the medium to STA 206B. The AP 204A may transmit beamformed message 620 such that it substantially nulls interference at STA 206C or at STA 206D. It is beneficial that substantially no interference is caused at the receiver side of the STA 206C and STA 206D communication because it facilitates reception of the intended signal. It is also beneficial that substantially no interference is caused at the transmission side of the STA 206C and STA 206D communication because it directly avoids that the transmitter defers to AP 204A during the AP 204A transmission. In some embodiments, the AP 204 may not be able to completely null all interference at the STA 206C or STA 206D but the transmission of the beamformed message 620 may reduce the interference or signal level at the STA 206C or STA 206D below a threshold such that the STA 206C or STA 206D may safely transmit or receive messages. In an embodiment where STA 206C and STA 206D have multiple antennas 316, AP 204A may substantially null interference at the particular antennas 316 that STA 206C and STA 206D use for their communication.

Referring to FIG. 6, in certain embodiments where the direction of STA 206 communication 230 is known, AP 204A may substantially null interference at the receiving STA 206 (e.g., STA 206D). If the AP 204A knows that STA 206C is transmitting to STA 206D, AP 204A may only substantially null interference at STA 206D to facilitate reception of the transmission.

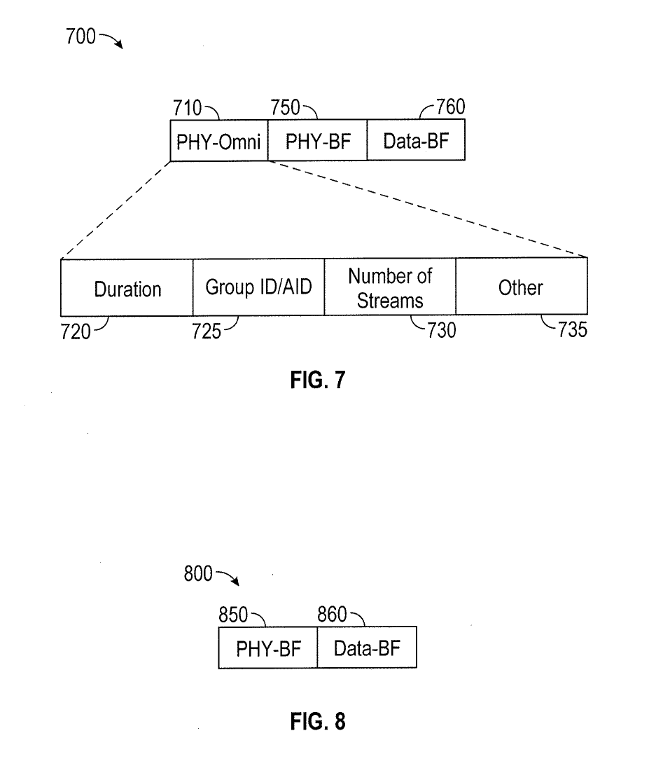

The AP 204A transmission illustrated in FIGS. 5 and 6 and described above may be in the form of a physical layer data unit (PPDU). FIG. 7 is a diagram of the structure of the type of PPDU 700 that may be transmitted by AP 204A. The three portions of the PPDU 700 illustrated are a PHY-Omni 710, PHY-beamforming (PHY-BF) 750, and a Data-beamforming (Data-BF) 760 portion. The PHY-Omni is a portion of the PPDU 700 preamble that is not precoded and is therefore sent to and received by all STAs 206 within range of the transmission. The PHY-Omni 710 portion may include a duration field 720 indicating the duration of the entire PPDU 700 packet, a group identifier (Group ID) or partial association identifier (AID) field 725 that identifies one or more groups of STAs 206 that may be the intended recipient of the PPDU 700, a field 730 indicating the number of streams allocated for communication to each STA 206 in the group, and a field 735 for other PPDU 700 information. The PHY-BF 750 and Data-BF 760 are precoded and are beamformed portions of the PPDU 700 that are sent to and received by only the intended recipients. In the embodiment shown in FIG. 6, the PHY-BF 750 and Data-BF 760 portions of the AP 204A transmission are sent to and received by STA 206B and are sent such that interference (or signal levels) at STAs 206C and 206D is substantially nulled.

The PHY-Omni 710 portion of the PPDU 700 transmitted may create inefficiencies in a CSMA mechanism because STA 206C and STA 206D still receive and decode the PHY-Omni 710 portion of the PPDU 700 and will defer transmission for the duration of the PPDU 700. However, the AP 204A may allow transmissions between STA 206C and STA 206D in certain embodiments.

In one embodiment, the PPDU 700 sent by AP 204A is a multi-user PPDU (MU-PPDU). The PHY-Omni 710 portion indicates that STA 206B, 206C, and 206D are in the same group that may be intended recipients of the PPDU 700 and that the number of streams allocated to STA 206C and STA 206D is set to zero for each. The AP 204A indicates to the STAs 206 that whenever they see zero data streams allocated to them and the interference or a signal level at the STAs 206 is below a threshold during the PHY-BF 750 and Data-BF 760 portions of the transmission, they may begin transmitting their own communications. This indication may be in the form of a management frame or other signal sent before transmission (e.g., in a beacon), at the time of associating the Group ID and number of streams, or after association of the Group ID and number of stream. In this embodiment, multiple STAs 206 may be in the same group and be allocated zero data streams. However, only those STAs 206 that whose interference or signal level is substantially nulled or reduced below a threshold (e.g., STA 206C and STA 206D in FIG. 6) will be able to transmit and/or receive during the AP 204A transmission.

In one embodiment, the PPDU 700 sent by AP 204A is a multi-user PPDU (MU-PPDU). The PHY-Omni 710 portion indicates that STA 206B, 206C, and 206D are in the same group that may be intended recipients of the PPDU 700 and that the number of streams allocated to STA 206C and STA 206D is a non-zero value for each. Even though the PHY-Omni 710 portion indicates streams are allocated to the STAs 206C and 206D, the AP 204A does not transmit any energy on those streams, i.e. they represent a null. The advantage in this case is that STAs 206C and STA 206D know on which spatial streams, i.e. on which antennas, the AP204A is nulling interference. The PHY-Omni 710 portion in this case may include an indication per each STA 206 that the allocated spatial streams are not used.

In another embodiment, the PPDU 700 sent by AP 204A may be a single-user PPDU or a MU-PPDU. In this embodiment, the Group ID field 725 of the PPDU 700 does not indicate that STA 206C and STA 206D are in a group of intended recipients. The AP 204A indicates to the STAs 206 that whenever they are not the intended recipients and whenever the interference or signal level at the STA 206 is substantially nulled or reduced below a threshold during the PHY-BF 750 and Data-BF 760 portions of the transmission, they may ignore the PPDU 700 and begin transmitting their own communications. This indication may be in the form of a management frame or other signal sent before transmission (e.g., in a beacon), at the time of associating the Group ID and number of streams, or after association of the Group ID and number of streams. In this embodiment, multiple STAs 206 may not be in a group of intended recipients. However, only those STAs 206 that whose interference or signal level is substantially nulled or reduced below a threshold (e.g., STA 206C and STA 206D in FIG. 6) will be able to transmit and/or receive during the AP 204A transmission.

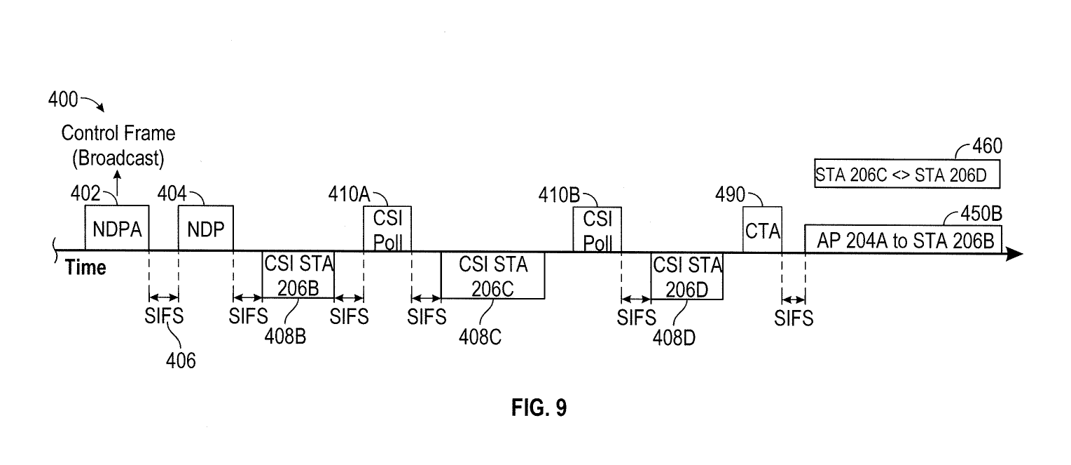

The AP 204A may also precede its transmission of the PPDU 700 with a non-precoded packet that explicitly states to certain STAs 206 that they are allowed to transmit during the PHY-BF 750 and Data-BF 760 portions of the PPDU 700. For example, the AP 204A may send a packet to STA 206C and STA 206D prior to sending the PPDU 700 indicating that STA 206C and STA 206D may transmit during the AP 204A PPDU 700 transmission. In one aspect, as illustrated in the sequence diagram of FIG. 9, the packet is a concurrent transmission allowance (CTA) indication frame 490 that may include the address of STA 206C and STA 206D and the antennas 316 that are to be nulled out by the PPDU 700 transmission and may be used for communication. The AP 204A undergoes the same CSI FB sequence as described above and illustrated in FIGS. 4 and 5 to collect this information. The packet may also contain a time frame during which transmission is allowed or other transmission parameters useful for coexistence (e.g., maximum transmission power). In one aspect, the transmitter (e.g., STA 206C) may first check that no interference or substantially no interference is present before transmitting to STA 206D. STA 206C may first send a clear-to-send (CTS) to STA 206D or it may listen for other signals in the medium before transmitting. In another aspect, the transmitter (e.g., STA 206C) may transmit irrespective of interference in the medium.

FIG. 8 is a diagram of an embodiment where the PPDU sent by AP 204A is a precoded SU-PPDU 800 which only contains PHY-BF 850 and Data-BF 860 portions of the PPDU. STAs 206, other than the intended recipients, will not receive any portion of the PPDU 800 because the PHY-Omni portion is not present. For example, STA 206C and STA 206D will not receive any portion of the AP 204A transmission and can access the medium as if the medium was idle. In order to avoid possible interference, the STA 206C may send a packet prior to transmission to confirm that substantially no interference will take place. The packet may take the form of a CTA frame, a CTS or any other signal to confirm substantially no interference with the STA 206C and STA 206D communication.

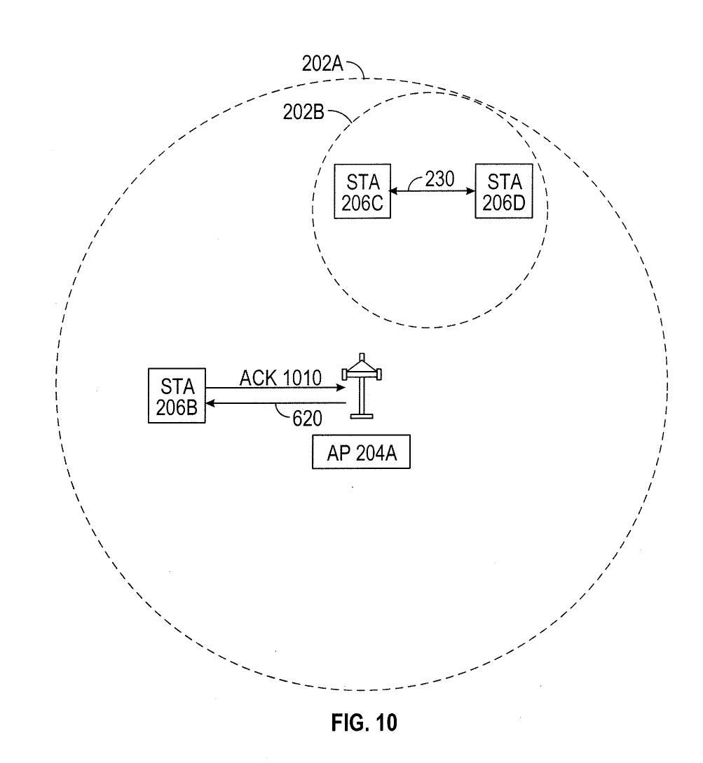

FIG. 10 is a diagram that illustrates an example where the AP 204A transmission may require an acknowledgment (ACK) frame 1010 from the intended recipient (STA 206B). In certain aspects, the ACK 1010 from STA 206B may interfere with the communication 230 between STA 206C and STA 206D. In one aspect, the AP 204A may restrict the STA 206C and STA 206D communication 230 to allow transmission only during the duration of the PHY-BF and Data-BF portions of a PPDU. In another aspect, the AP 204A may set its acknowledgment policy to a no-ACK policy whenever AP 204A enables communication between STA 206C and STA 206D so that STA 206B does not send an ACK frame.

In certain embodiments, transmission from STAs 206 may interfere with reception of the AP 204A transmission. For example, the transmission from STA 206C to STA 206D may interfere with the reception at STA 206B. In one aspect, as illustrated in the sequence diagram of FIG. 11, AP 204A may precede its transmission 450B with a packet 480 intended for STA 206B. The packet 480 may be in the form of a CTA or request to send (RTS) frame. STA 206B may then send a response 485 to the packet by sending a CTA response (CTA-R) frame or a CTS which would allow STA 206C to STA 206D to estimate pathloss towards STA 206B and thus estimate the interference they would cause to STA 206B. The response 485 sent by STA 206B may include information regarding the transmission power used by STA 206B, antennas 316 used for transmission, duration of the transmission or any transmission parameters useful for coexistence.

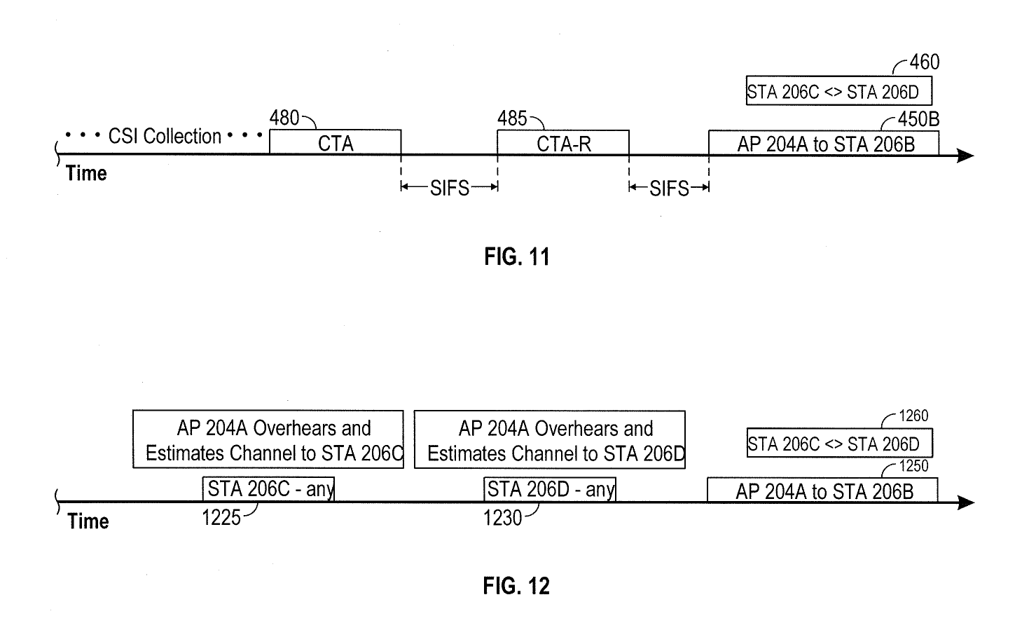

In another embodiment, certain STAs 206 may not be associated with APs 204 and may communicate via a peer-to-peer network (e.g. TDLS, WiFi-Direct) between the STAs 206. For example, the AP 204A may not be able to collect CSI for these STAs 206 in the same way as shown in FIGS. 4, 5 and 9 because the AP 204 cannot exchange control or management frames (e.g., CSI poll, CSI FB, CTA, etc.) with the peer-to-peer STAs 206. In one embodiment, as shown in the sequence diagram of FIG. 12, AP 204A may be able to estimate CSI by detecting any transmissions 1225 from STA 206C and any transmissions 1230 from STA 206D and assuming channel reciprocity. The AP 204A then uses the estimated CSI to precode the data sent by each antenna 316 to send data 1250 to STA 206B and null interference 1260 at STAs 206C and 206D to permit communication between STA 206C and STA 206D.

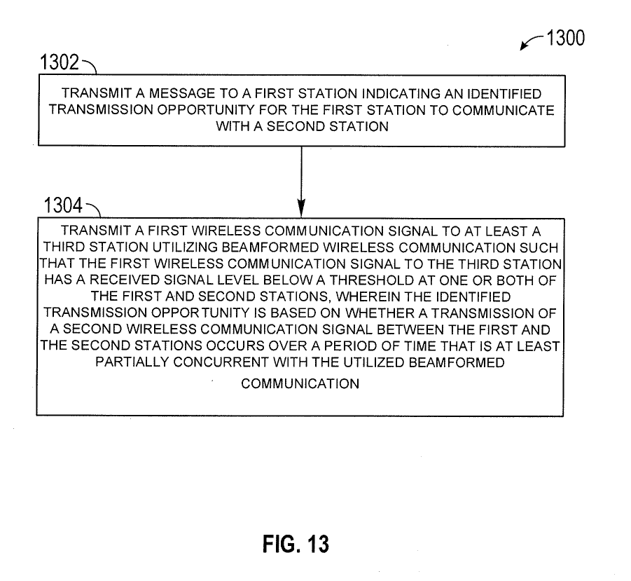

FIG. 13 is a flow chart of an exemplary method 1300 of wireless communication, in accordance with certain embodiments described herein. Although the method 1300 is described herein with reference to communications among a AP 204 and STAs 206 as discussed above with respect to FIGS. 2B, 6, and 10, a person having ordinary skill in the art will appreciate that the method 1300 may be implemented by other suitable devices and systems. For example, the method 1300 may be performed by a STA 206 or a plurality of APs 204. Although the method 1300 is described herein with reference to a particular order, in various embodiments, blocks herein may be performed in a different order, or omitted, and additional blocks may be added. For example, the operational block 1304 may be sent after operational block 1306 in certain embodiments.

In operation block 1302 the method comprises transmitting a message to a first station indicating an identified transmission opportunity for the first station to communicate with a second station. In operational block 1304, the method further comprises transmitting a first wireless communication signal to at least a third station utilizing beamformed wireless communication such that the first wireless communication signal to the third station has a received signal level below a threshold at one or both of the first and second stations, wherein the identified transmission opportunity is based on whether a transmission of a second wireless communication signal between the first and the second stations occurs over a period of time that is at least partially concurrent with the utilized beamformed communication.

In some embodiments, an apparatus for wireless communication may perform some of the embodiments described herein. In some embodiments, the apparatus comprises means for transmitting a message to a first station indicating an identified transmission opportunity for the first station to communicate with a second station. The apparatus further comprises means for transmitting a first wireless communication signal to at least a third station utilizing beamformed wireless communication such that the first wireless communication signal to the third station has a received signal level below a threshold at one or both of the first and second stations, wherein the identified transmission opportunity is based on whether a transmission of a second wireless communication signal between the first and the second stations occurs over a period of time that is at least partially concurrent with the utilized beamformed communication.

It should be understood that any reference to an element herein using a designation such as “first,” “second,” and so forth does not generally limit the quantity or order of those elements. Rather, these designations can be used herein as a convenient wireless device of distinguishing between two or more elements or instances of an element. Thus, a reference to first and second elements does not mean that only two elements can be employed there or that the first element can precede the second element in some manner. Also, unless stated otherwise a set of elements can include one or more elements.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

What is claimed is:

1. A method of wireless communication, comprising:
transmitting a message to a first station indicating an identified transmission opportunity for the first station to communicate with a second station; and
transmitting a first wireless communication signal to at least a third station utilizing beamformed wireless communication such that the first wireless communication signal to the third station has a received signal level below a threshold at one or both of the first and second stations;
wherein the identified transmission opportunity is based on whether a transmission of a second wireless communication signal between the first and the second stations occurs over a period of time that is at least partially concurrent with the utilized beamformed communication.

2. The method of claim 1, wherein transmitting the first wireless communication signal comprises transmission of a physical layer data unit (PPDU).

3. The method of claim 2, wherein the message includes a field indicating the number of data streams allocated for the at least third station and the identified transmission opportunity is further based on whether the first and second stations have been allocated zero data streams.

4. The method of claim 2, wherein the PPDU comprises a group identifier field which excludes the first and second stations as being intended recipients of the PPDU.

5. The method of claim 4, wherein the identified transmission opportunity is further based on whether the first and second stations are excluded from the group identifier field of the PPDU and based on whether a received signal level of the first wireless communication signal at one or both of the first and second stations is below the threshold.

6. The method of claim 1, wherein the message comprises one or more of:
address information of the first and second stations;
antenna information indicating one or more antennas to be used by the first and second stations;
time information indicating a duration for allowable communication; and
transmission information indicating a maximum transmission power.

7. The method of claim 1, wherein the message indicates that the transmission of the second wireless communication signal ends at the same time or before the end of the transmission of the first wireless communication.

8. The method of claim 1, further comprising setting an acknowledgment policy of a device transmitting the first wireless communication signal to a no-acknowledgement policy with respect to the third device during the transmission of the first wireless communication signal.

9. The method of claim 1, wherein the message comprises a frame transmitted before the transmission of the first wireless communication signal, the frame indicating the identified transmission opportunity for the first station to communicate with the second station.

10. The method of claim 2, wherein the message is transmitted in an omni portion of a physical layer (PHY) of the PPDU.

11. The method of claim 1, further comprising:
detecting transmissions from one or both of the first and second stations; and
estimating channel state information based on the detected transmissions, wherein the transmission opportunity is based on the channel state information.

12. The method of claim 1, further comprising:
transmitting a third wireless communication signal to the third station prior to transmitting the first wireless communication signal; and
receiving a response signal from the third station indicating that the third station may receive the first wireless communication signal, the response signal providing pathloss information, wherein the transmission opportunity is based on the pathloss information.

13. An apparatus for wireless communication, comprising:
a transmitter configured to transmit a message to a first station indicating an identified transmission opportunity for the first station to communicate with a second station, the transmitter further configured to transmit a first wireless communication signal to at least a third station utilizing beamformed wireless communication such that the first wireless communication signal to the third station has a received signal level below a threshold at one or both of the first and second stations;
wherein the identified transmission opportunity is based on whether a transmission of a second wireless communication signal between the first and the second stations occurs over a period of time that is at least partially concurrent with the utilized beamformed communication.

14. The apparatus of claim 13, wherein the first wireless communication signal comprises a physical layer data unit (PPDU).

15. The apparatus of claim 14, wherein the message includes a field indicating the number of data streams allocated for the at least third station and the identified transmission opportunity is further based on whether the first and second stations have been allocated zero data streams.

16. The apparatus of claim 14, wherein the PPDU comprises a group identifier field which excludes the first and second stations as being intended recipients of the PPDU.

17. The apparatus of claim 16, wherein the identified transmission opportunity is further based on whether the first and second stations are excluded from the group identifier field of the PPDU and based on whether a received signal level of the first wireless communication signal at one or both of the first and second stations is below the threshold.

18. The apparatus of claim 13, wherein the message comprises one or more of:
address information of the first and second stations;
antenna information indicating one or more antennas to be used by the first and second stations;
time information indicating a duration for allowable communication; and
transmission information indicating a maximum transmission power.

19. The apparatus of claim 13, wherein the message indicates that the transmission of the second wireless communication signal ends at the same time or before the end of the transmission of the first wireless communication.

20. The apparatus of claim 13, further comprising a processor configured to set an acknowledgment policy of a device transmitting the first to a no-acknowledgement policy with respect to the third device during the transmission of the first wireless communication signal.

21. The apparatus of claim 13, wherein the message comprises a frame transmitted before the first wireless communication signal, the frame indicating the identified transmission opportunity for the first station to communicate with the second station.

22. The apparatus of claim 14, wherein the message is transmitted in an omni portion of a physical layer (PHY) of the PPDU.

23. The apparatus of claim 13, further comprising a receiver is configured to:
detect transmissions from one or both of the first and second stations; and
estimate channel state information based on the detected transmissions, wherein the transmission opportunity is based on the channel state information.

24. The apparatus of claim 13, wherein the transmitter is further configured to transmit a third wireless communication signal to the third station prior to transmitting the first wireless communication signal and the receiver further configured to receive a response signal from the third station indicating that the third station may receive the first wireless communication signal, the response signal providing pathloss information, wherein the transmission opportunity is based on the pathloss information.

25. An apparatus for wireless communication, comprising:
means for transmitting a message to a first station indicating an identified transmission opportunity for the first station to communicate with a second station; and
means for transmitting a first wireless communication signal to at least a third station utilizing beamformed wireless communication such that the first wireless communication signal to the third station has a received signal level below a threshold at one or both of the first and second stations;
wherein the identified transmission opportunity is based on whether a transmission of a second wireless communication signal between the first and the second stations occurs over a period of time that is at least partially concurrent with the utilized beamformed communication.

26. The apparatus of claim 25, wherein the message includes a field indicating the number of data streams allocated for the at least third station and the identified transmission opportunity is further based on whether the first and second stations have been allocated zero data streams.

27. The apparatus of claim 25, further comprising:
means for transmissions from one or both of the first and second stations; and
means for estimating channel state information based on the detected transmission, wherein the transmission opportunity is based on the channel state information.

28. The apparatus of claim 25, further comprising:
means for transmitting a third wireless communication signal to the third station prior to transmitting the first wireless communication signal; and
means for receiving a response signal from the third station indicating that the third station may receive the first wireless communication signal, the response signal providing pathloss information, wherein the transmission opportunity is based on the pathloss information.

29. A non-transitory computer readable medium comprising instructions that when executed cause a processor to perform a method of:
transmitting a message to a first station indicating an identified transmission opportunity for the first station to communicate with a second station; and
transmitting a first wireless communication signal to at least a third station utilizing beamformed wireless communication such that the first wireless communication signal to the third station has a received signal level below a threshold at one or both of the first and second stations;
wherein the identified transmission opportunity is based on whether a transmission of a second wireless communication signal between the first and the second stations occurs over a period of time that is at least partially concurrent with the utilized beamformed communication.

30. The medium of claim 29, further comprising instructions that when executed cause a processor to perform a method of:
detecting transmissions from one or both of the first and second stations; and
estimating channel state information based on the detected transmissions, wherein the transmission opportunity is based on the channel state information.
